(19) United States
(12) Patent Application Publication
(10) Pub. No.: US 2009/0083747 A1
(43) Pub. Date: Mar. 26, 2009

(54) METHOD FOR MANAGING APPLICATION PROGRAMS BY UTILIZING REDUNDANCY AND LOAD BALANCE

(76) Inventors: Mao-Gue Huang, Taipei City (TW); Hung-Wen Chiou, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/033,022

(22) Filed: Feb. 19, 2008

(30) Foreign Application Priority Data
Sep. 20, 2007 (TW) 096135094

(51) Int. Cl. G06F 9/50

(52) U.S. Cl. 718/104

(57) ABSTRACT

A method for managing application programs includes: monitoring whether there is at least an application program which is unresponsive in a plurality of started application programs; and automatically restarting the application program which is unresponsive, and averagely allocating a system resource for the plurality of application programs according to a number of the plurality of application programs.

### BACKGROUND OF THE INVENTION

1. Field of the Invention

The present invention relates to a method for managing application programs, and more particularly, to a method for managing application programs and averagely allocating system resources by utilizing redundancy and load balance.

2. Description of the Prior Art

At present, in general producing lines, platforms may generate related information of the platforms or products between performing or producing processes, for example, temperature, voltage, electric current and various gas flows. However, this information generates data of different capacities according to different recording approaches. In addition, this information must be stored in databases for quality analysis of the next products or situation analysis of the platforms. As a result, it is very difficult to manage this information. There are two storing approaches of the databases, which are centralization or distribution. Managers must collect all information distributed in the various platforms to perform further analysis and management.

The data stored in the database may be further analyzed, calculated and examined by compiled application program software, to detect software and hardware situations of the current platform and producing situations. The application program software utilizes the system resource to perform the aforementioned operations, but in general the system resource is limited. Accordingly, how to utilize the limited system resource is an important issue to be solved.

### SUMMARY OF THE INVENTION

It is therefore one of the objectives of the claimed invention to provide a method for managing application programs, to solve the above-mentioned problems.

According to one embodiment of the claimed invention, a method for managing application programs comprises monitoring whether there is at least an application program which is unresponsive in a plurality of started application programs; and automatically restarting the unresponsive application program, and averagely allocating a system resource for the plurality of application programs according to a number of the plurality of application programs.

According to yet another embodiment of the present invention, a method for managing application programs comprises monitoring whether there is at least an application program which is unresponsive in a plurality of started application programs; automatically restarting the unresponsive application program, and averagely allocating a system resource for the plurality of application programs according to a number of the plurality of application programs; receiving at least a user controlling command via a management interface; and controlling operations of at least an application program in the plurality of application programs according to the user controlling command.

According to yet another embodiment of the present invention, a method for managing application programs comprises monitoring whether there is at least an application program which is unresponsive in a plurality of started application programs; automatically restarting the unresponsive application program, and averagely allocating a system resource for the plurality of application programs according to a number of the plurality of application programs; and setting numbers of the application programs which are performed simultaneously via a management interface.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an operation flowchart of a management program, a management interface, a database, a software development kit (SDK) and an application program according to an embodiment of the present invention.

FIG. 2 is a diagram illustrating the management interface shown in FIG. 1 according to an embodiment of the present invention.

FIG. 3 is a diagram illustrating the management program applied in a producing flow according to another embodiment of the present invention.

FIG. 4 is an operation flowchart of the management program shown in FIG. 1.

FIG. 5 is an operation flowchart of the software development kit (SDK) shown in FIG. 1.

### DETAILED DESCRIPTION

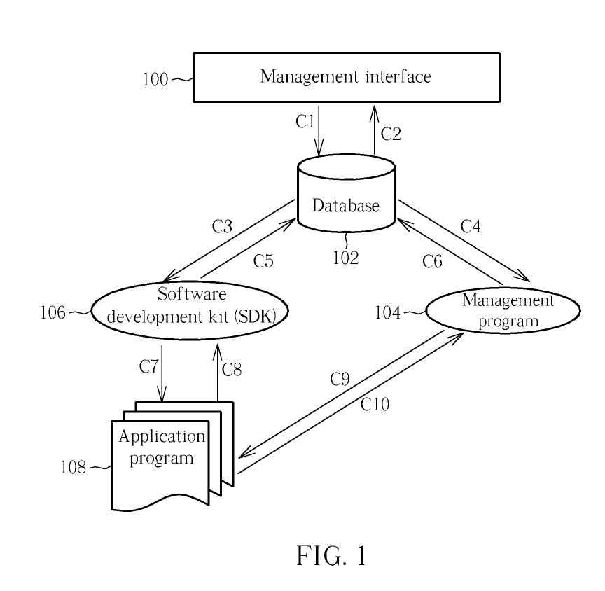

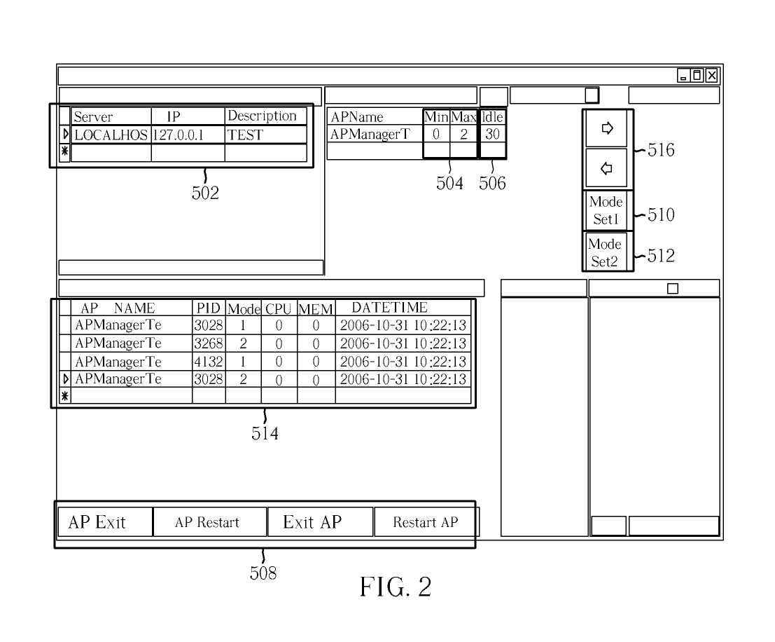

Please refer to FIG. 1. FIG. 1 is a diagram illustrating an operation flowchart of a management program 104, a management interface 100, a database 102, a software development kit (SDK) 106 and application programs 108 according to an embodiment of the present invention. A user utilizes the management interface 100 to transmit a user controlling command C1 for monitoring the plurality of started application programs 108. The management interface 100 controls operations of at least an application program of the plurality of started application programs 108. If at least an application program of the plurality of started application programs is unresponsive, the management program 104 further automatically restarts the unresponsive application programs 108, and averagely allocates a system resource for the plurality of application programs 108 according to a number of the plurality of application programs 108. In this embodiment, the management program 104 is a daemon based on background approach, however, this is not meant to be a limitation of the present invention. The relationships of each components in FIG. 1 are detailed as follows. First, as shown in FIG. 1, the user transmits the user controlling command C1 via the management interface 100 to modify the plurality of application programs 108, and records the user controlling command C1 in the database 102 via the management interface 100. Please refer to FIG. 2. As shown in FIG. 2, the management interface 100 comprises a server and application program modifying module 502, a setting minimum or maximum started number module 504, a setting idle time module 506, a setting performing and end module 508, a first mode module 510, a second mode module 512, a displaying module 514, and a setting group module 516. The applications of the above-mentioned various modules will be describe briefly in the following.

The server and application program modifying module 502 can select a server as (without limitation) a Windows operation system or a Linux operation system, and the server and application program modifying module 502 can display at least a related information of the server of the selected operation system, for example, a server name, an IP address of the server and a server situation. The setting minimum or maximum started number module 504 can set the minimum or maximum started numbers of the application programs 108 shown in FIG. 1 for synchronous performance, and the management interface 100 shown in FIG. 1 is for averagely allocating a system resource according to the started numbers. The setting idle time module 506 can set the allowed idle time of the application programs 108, where if one of the unresponsive time (i.e. idle time) of the application programs 108 is greater than the set idle time, one of the application programs 108 is regarded as an unresponsive application program. At this time, the management program 104 shown In FIG. 1 restarts one of the unresponsive application programs 108, wherein calculations of the unresponsive time (i.e. idle time) are determined by calculating a time difference between the return time of the application programs 108 (i.e. last new updating time) and the current time of the management interface 100. When the time difference is greater than a threshold value, then one of the application programs 108 is the unresponsive application program. The setting performing and end module 508 is an operating interface for setting the application programs 108 shown in FIG. 1 to normally end, normally start, forcibly end execution or restart. When one of the application programs 108 is set to forcibly end execution, it represents that the time of occupying the system resources by one of the application programs 108 is greater than a predetermined time value. When one of the application programs 108 does not normally end, then the user forcibly sets an end execution via the management interface 100 to release the occupied system resources. The first mode module 510 is utilized for setting the operations of the application programs 108 to correspond to a first mode, i.e. redundancy mode. When one of the application programs 108 is set as the first mode, one of the application programs 108 may process all platform data because one of the application programs 108 does not need to perform load balance control, for example, data of the plurality of platforms 200, 202, 204 and 206. The second mode module 512 is utilized for setting the operations of the application programs 108 to correspond to a second mode, i.e. redundancy and load balance mode. Therefore, when the application programs 108 are set as the second mode, the plurality of application programs 108 averagely allocate the system resources and process data of one platform via the control of load balance. The setting group module 516 is utilized for setting the data of one platform processed by the application programs 108, in other words, the setting group module 516 of the management interface 100 is utilized for setting the application programs 108 to process at least a data resource of the plurality of data resources. The displaying module 514 displays state information of the monitored application programs 108. The management interface 100 may also set the number of application programs 108 for simultaneous performance.

In this embodiment, user controlling command C1 can be considered as one of two types of user controlling commands. One is a first type command C3 communication with the software development kit (SDK) 106 of the application programs 108 to restart or end the application programs 108; the other is a second type command C4 communicating with the management program 104 to monitor the operations of the application programs 108. Please note that the aforementioned user controlling command C1 is not limited to two types. As shown in FIG. 1, when the user controlling command C1 is the second type command C4, it represents that the user sets the plurality of functions of the management program 104 via the management interface 100, wherein the plurality of functions are utilized for controlling the application programs 108. Accordingly, the management interface 100 transmits the second type command C4 to the management program 104, and after the management program 104 receives the second type command C4, the management interface 100 monitors the application programs 108 to perform an operation command C10 for starting, restarting or forcibly ending execution according to the second type command C4. Therefore, when the application programs 108 receive the operation command C10, the application programs 108 perform a command C8 to store a return time (i.e. the current time of the system) into a variable of the software development kit (SDK) 106. Then, the software development kit (SDK) 106 further performs an updating command C5 to transmit the variable, which comprises time information, to a database 102 for recording time. As a result, in this embodiment, C1, C4, C10, C8 and C5 are completely performed to start the application programs 108.

According to another embodiment of the present invention, when the idle time of one of the application programs 108 is less than the idle time set by the management interface 100 and one of the application programs 108 ends the execution, this represents that one of the application programs 108 normally ends the execution. As shown in FIG. 1, when the user controlling command C1 is the first type command C3, the management interface 100 utilizes the first type command C3 to communicate the application programs 108 with, wherein the first type command C3 is utilized for normally ending the execution of the application programs 108, and one of the application programs 108 comprises a software development kit (SDK) 106, for returning a message to represent that one of the application programs 108 operates normally at this time. As a result, when the software development kit (SDK) 106 receives the first type command C3 transmitted by the management interface 100, the software development kit (SDK) 106 transmits a command C7 to the application programs 108 to normally end the operation. Therefore, in this embodiment, C1, C3 and C7 are completely performed to normally end the application programs 108.

Furthermore, according to another embodiment of the present invention, the management interface 100 determines whether there is one of the application programs 108 which is unresponsive in the plurality of the application programs 108 according to the plurality of messages returned by the plurality of application programs 108. Accordingly, when the idle time of one of the application programs 108 is less than the idle time set by the management interface 100 and one of the application programs 108 does not transmit the updating command C5 shown in FIG. 1 to update a latest return time recorded by the database 102, the management interface 100 will determine that one of the application programs 108 is unresponsive, and therefore, the management interface 100 will forcibly end the execution of one of the unresponsive application programs 108. In other words, in FIG. 1, when the management interface 100 detects that the return time recorded by the application programs 108 is greater than the idle time set by the management interface 100, it will determine that one of the application programs 108 is an unresponsive application programs 108. Therefore, the management interface 100 transmits the user controlling command C1 to the database 102 for storing the user controlling command C1. The management program 104 reads the user controlling command C1 from the database 102 to receive the second type command C4, for notifying the management program 104 to forcibly end the executions of the application programs 108. The management program 104 then performs the second type command C4 to generate the operation command C10. In this embodiment, the operation command C10 is an operation of forcibly ending execution. Therefore, the management program 104 transmits the generated operation command C10 to the application programs 108 to forcibly end the executions of the application programs 108. As a result, in this embodiment, C1, C4 and C10 are completely performed to forcibly end the application programs 108.

According to another embodiment of the present invention, as shown in FIG. 1, the application programs 108 further return a message C9 to the management program 104, wherein the message C9 comprises a utility rate of the CPU (central processing unit), a utility rate of the memory and a return time (i.e. the latest updating time). Then, the management program 104 receives and processes the message C9 to generate a message C6, and transmits the message C6 to the database 103, and the database 102 receives and stores the message C6 in a data table. Lastly, the management interface 100 reads the database 102 to the executing states of the application programs 108 via a message C2 outputted by the database 102, wherein the message C2 comprises the utility rate of the CPU, the utility rate of the memory and the return time. Accordingly, in this embodiment, C9, C6 and C2 are completely performed to attain the state where the application programs 108 utilize the system resource.

Please note that architectures and principles of the aforementioned utility rate of the CPU, memory and the database 102 are well known in the art, and therefore not explained in detail here for the sake of brevity.

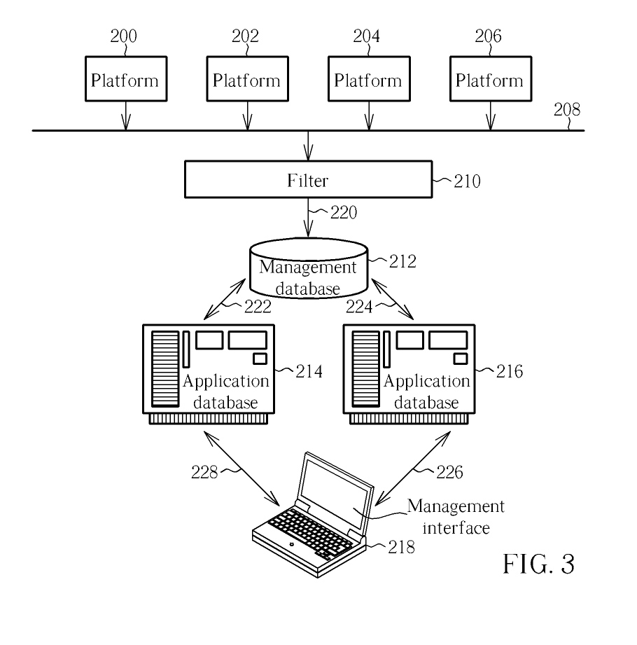

Please refer to FIG. 3. FIG. 3 is a diagram illustrating the management program 104 applied in a producing flow according to another embodiment of the present invention. As shown in FIG. 3, the plurality of the platforms (i.e. the plurality of data resources) 200, 202, 204 and 206 generate the plurality of platform information (for example, temperature, voltage, electric current, various gas flows) in a producing flow, and transmit the aforementioned platform information to a filter 210 via an internal network 208 to filter the plurality of received platform information, wherein the filter 210 is utilized for filtering the plurality of platform information in the internal network 208 and transforms the plurality of platform information to a data mode of a management database 212. The filter 210 further transmits the filtered and transformed plurality of platform information to the management database 212 via an internal network 220. The management database 212 stores the plurality of platform information in a data table, wherein the management database 212 records IP addresses of the plurality of platform information (for example application database 214 and 216, wherein the application database 214 and 216 form the database 102 shown in FIG. 1) and the plurality of system resources. The user sets and starts the application programs 108 shown in FIG. 1 via a management interface 218, wherein the management interface 218 is the management interface 100 shown in FIG. 1, and the management interface 218 starts the plurality of application programs 108 shown in FIG. 1 in the application database 214 and 216 via (without limitation) internal networks 226 and 228, for example, the hold tool application program and the hold lot application program. As a result, the management program 104 transmits the related information of the application programs 108 (for example, the utility rate of the CPU, the utility rate of the memory and the latest updating time) and stores this information into the management database 212. In addition, the management program 104 shown in FIG. 1 in the application database 214 and 216 calculates and examines the usable system resources in the management database 212 according to the application programs 108 with different objectives, for example, CPU resources, memory resources and relative system hardware resources, and then returns the calculating result and examining result and records them into the application database 214 and 216. The management program 104 averagely allocates the usable system resource for the plurality of started application programs 108 according to the aforementioned results. Therefore, the management program 104 shown in FIG. 1 in the application database 214 and 216 returns the executing state information of the application programs 108 to the management interface 218 for monitoring.

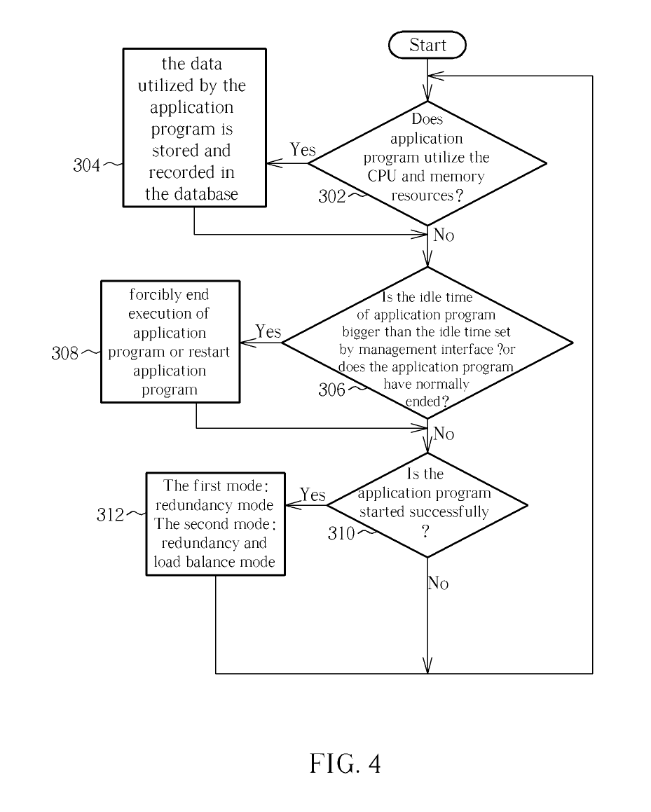

Please refer to FIG. 1 in conjunction with FIG. 4. FIG. 4 is an operation flowchart of the management program 104 shown in FIG. 1. First, in Step 302, the management program 104 detects whether the application programs 108 utilize the CPU and memory resources. If Step 302 is true, the data utilized by the application programs 108 is stored and recorded in the database 102 (Step 304), and then Step 306 is performed; if Step 302 is false, Step 306 is directly performed. In Step 306, the management program 104 detects whether the idle time of the application programs 108 is greater than the idle time set by the management interface 100 or whether one of the application programs 108 has normally ended. If the idle time of the application programs 108 is greater than the idle time set by the management interface 100, the management program 104 forcibly ends the executions of the application programs 108 or restarts the application programs 108 (Step 308), and then Step 310 is performed; if Step 306 is false, Step 310 is directly performed. In Step 310, the management program 104 detects whether one of the application programs 108 is started successfully. If one of the application programs 108 is started successfully, then Step 312 is performed. At this time, the database 102 shown in FIG. 1 records the first mode (redundancy mode) or the second mode (redundancy and load balance mode) set by the management interface 100 shown in FIG. 1. Then, the flow returns to Step 302 for continuously monitoring the next application program. If one of the application programs 108 is started falsely, the flow directly returns to Step 302 to continuously monitor the next application program. After all of the application programs 108 are monitored, the flow may return to the first application programs 108 to restart and repeatedly perform the same operations. When the management program 104 finds that one of the application programs 108 is previously started/restarted falsely, one of the application programs 108 may be restarted again. For example, when a network connection error occurs, one of the application programs 108 may be started falsely, and then the management program 104 may repeatedly restart one of the application programs 108 until the network is successful and one of the application programs 108 is started successfully.

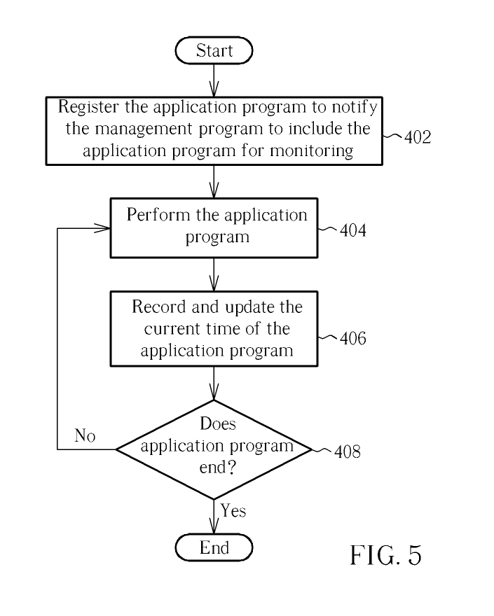

Please refer to FIG. 1 in conjunction with FIG. 5. FIG. 5 is an operation flowchart of the software development kit (SDK) 106 shown in FIG. 1. First, in Step 402, the software development kit (SDK) 106 shown in FIG. 1 performs a register program code to register the application programs 108 in the database 102, for example, Register (“AP name”) corresponds to a procedure of program language for inputting a parameter “AP name” into the procedure “Register( )” to perform a register function. In Step 404, one of the application programs 108 is performed. Next, in Step 406, the software development kit (SDK) 106 performs an updating program code to record and update the current time of the application programs 108 in the database 102 to notify the management interface 100 shown in FIG. 1 that one of the application programs 108 is normally operated, for example, UpdateTime( ) corresponds to a procedure of program language for updating time according to the current time of the computer. In addition, in Step 408, software development kit (SDK) 106 performs an exit program code to detect whether one of the application programs 108 ends, for example, Exit( ) corresponds to a procedure of program language for ending execution. If one of the application programs 108 does not end, the flow returns to Step 404. Otherwise, the flow is ended.

Please note that, in this embodiment, the relative information of the application programs 108 are all stored in a data table and are recorded in the database 102 shown in FIG. 1. The database 102 may apply any feasible data storing format to store the information of the application programs 108, for example, program name, process ID (PID), return time (i.e. latest updating time), the utility rate of the CPU, the utility of the memory, idle time setting, platform name, and processing approach (e.g. the first mode, the second mode, forcibly ending execution, restarting, normal ending and normal starting).

In conclusion, the method for managing application programs provided by the present invention not only easily and quickly obtains the information of all relative platforms, but also means the managers or relative users can easily manage and monitor the information of all relative platforms via the management program 104, and modify the error information or update the new information synchronously in real time. Therefore, they can effectively utilize hardware resources according to current hardware architectures to averagely allocate hardware resources for the started application programs 108 and synchronously perform the started application programs 108. As a result, the method for managing application programs provided by the present invention not only quickly obtains information of platforms and easily manages and monitors the started application programs 108, but also effectively utilizes the hardware resources to increase the performance of the application programs 108.

Those skilled in the art will readily observe that numerous modifications and alterations of the device and method may be made while retaining the teachings of the invention.

What is claimed is:

1. A method for managing application programs, comprising:
monitoring whether there is at least an application program which is unresponsive in a plurality of started application programs; and
automatically restarting the application program which is unresponsive, and averagely allocating a system resource for the plurality of application programs according to a number of the plurality of application programs.

2. The method of claim 1, wherein each of the plurality of application programs comprises a software development kit (SDK) for returning a message to represent that the application program is currently operating normally.

3. The method of claim 1, wherein the step of monitoring the plurality of started application programs further comprises:
verifying whether there is an unresponsive application program in the plurality of started application programs according to a plurality of messages returned by the plurality of application programs.

4. The method of claim 2, wherein the message is a return time, and when the time difference between a latest return time of a specific application program in the plurality of application programs and a current time is greater than a threshold value, verifying whether the specific application program is the unresponsive application program.

5. The method of claim 1, further comprising:
receiving at least a user controlling command via a management interface; and
controlling operations of at least an application program in the plurality of application programs according to the user controlling command.

6. The method of claim 5, wherein the step of controlling operations of at least an application program in the plurality of application programs according to the user controlling command further comprises:
recording the user controlling command; and
performing a management program to read the user controlling command, and managing at least an application program in the plurality of application programs according to the user controlling command, wherein the management program is further utilized for automatically restarting the unresponsive application program, and averagely allocating a system resource for the plurality of application programs.

7. The method of claim 6, wherein the management program is a daemon based on background approach.

8. The method of claim 5, wherein the user controlling command is utilized for forcibly closing at least an application program which is unresponsive in the plurality of application programs.

9. The method of claim 5, wherein the user controlling command is utilized for restarting at least an application program which is unresponsive in the plurality of application programs.

10. The method of claim 1, further comprising:
setting numbers of the application programs which are performed simultaneously via a management interface.

11. The method of claim 1, wherein the system resource comprises a plurality of data resources.

12. The method of claim 11, further comprising:
setting each of the application programs which process at least a data resource in the plurality of the data resources via a management interface.
